(19) United States
(12) Patent Application Publication
(10) Pub. No.: US 2019/0011693 A1
(43) Pub. Date: Jan. 10, 2019

(54) ROTARY DRIVE APPARATUS

(71) Applicant: Nidec Corporation, Kyoto (JP)

(72) Inventor: Junya MIZUKAMI, Kyoto (JP)

(21) Appl. No.: 15/725,383

(22) Filed: Oct. 5, 2017

(30) Foreign Application Priority Data
Jul. 10, 2017 (JP) 2017-134860

(51) Int. Cl. G02B 26/08; G02B 7/02

(52) U.S. Cl. CPC G02B 26/0816; G02B 7/02

(57) ABSTRACT

A rotary drive apparatus is arranged to cause incoming light coming from a light source to be reflected, and rotate resulting reflected light, and includes a motor including a rotating portion arranged to rotate about a central axis extending in a vertical direction; and a flywheel supported by the rotating portion, and caused by the rotating portion to rotate about the central axis. The flywheel includes a lens arranged to allow the reflected light to pass therethrough; and a main body arranged to directly support the lens, or indirectly support the lens through a lens frame arranged to be in contact with at least a portion of a peripheral portion of the lens. At least one of the lens and the main body includes at least one projecting portion arranged to project toward another one of the lens and the main body. The other one of the lens and the main body includes at least one recessed portion into which the corresponding projecting portion is fitted.

### CROSS REFERENCE TO RELATED APPLICATIONS

This application claims the benefit of priority to Japanese Patent Application No. 2017-134860 filed on Jul. 10, 2017. The entire contents of this application are hereby incorporated herein by reference.

### BACKGROUND OF THE INVENTION

### 1. Field of the Invention

The present invention relates to a rotary drive apparatus.

### 2. Description of the Related Art

A known scanner apparatus used for position recognition in a head-mounted display (HMD) or the like typically has installed therein a mirror arranged to reflect incoming light coming from a light source, and a lens arranged to allow reflected light to pass therethrough. A known optical apparatus including a light-transmitting member, such as, for example, a lens, is described in, for example, JP-A 2009-283021.

In a configuration described in JP-A 2009-283021, a disk-shaped relay lens is fitted in a relay lens holder with the relay lens being held against a recessed portion defined in the relay lens holder. In addition, an adhesive is injected into a gap between a side surface of the relay lens and an inner surface of the relay lens holder to fix the relay lens and the relay lens holder. However, since the recessed portion is arranged to have a size sufficient for the relay lens, a displacement or rotation of the relay lens may occur even when the relay lens is fitted in the relay lens holder. This makes it difficult to attach the relay lens to the recessed portion at a desired position and at a desired angle with high precision.

### SUMMARY OF THE INVENTION

A rotary drive apparatus according to a preferred embodiment of the present invention is arranged to cause incoming light coming from a light source to be reflected, and rotate resulting reflected light, and includes a motor including a rotating portion arranged to rotate about a central axis extending in a vertical direction; and a flywheel supported by the rotating portion, and caused by the rotating portion to rotate about the central axis. The flywheel includes a lens arranged to allow the reflected light to pass therethrough; and a main body arranged to directly support the lens, or indirectly support the lens through a lens frame arranged to be in contact with at least a portion of a peripheral portion of the lens. At least one of the lens and the main body includes at least one projecting portion arranged to project toward another one of the lens and the main body. The other one of the lens and the main body includes at least one recessed portion into which the corresponding projecting portion is fitted.

In the rotary drive apparatus according to the above preferred embodiment of the present invention, each projecting portion, which is arranged to project from one of the lens and the main body toward the other one of the lens and the main body, is fitted into the corresponding recessed portion in the other one of the lens and the main body. This enables the lens to be attached, with high precision, to the main body at a desired circumferential position and at a desired angle with respect to the main body. In addition, the likelihood that a displacement or rotation of the lens will occur can be reduced.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a light source, a frame, and a rotary drive apparatus according to a first preferred embodiment of the present invention.

FIG. 2 is a vertical sectional view of the rotary drive apparatus according to the first preferred embodiment.

FIG. 3 is a perspective sectional view of a flywheel according to the first preferred embodiment.

FIG. 4 is a perspective view of a mirror according to the first preferred embodiment.

FIG. 5 is a perspective sectional view of a main body of the flywheel according to the first preferred embodiment.

FIG. 6 is a perspective view of a lens according to the first preferred embodiment.

FIG. 7 is a plan view of the lens according to the first preferred embodiment.

FIG. 8 is a partial perspective view of a lens according to a modification of the first preferred embodiment.

### DETAILED DESCRIPTION OF THE PREFERRED EMBODIMENTS

Hereinafter, preferred embodiments of the present invention will be described with reference to the accompanying drawings. It is assumed herein that a direction parallel to a central axis of a motor, which will be described below, is referred to by the term “axial direction”, “axial”, or “axially”, that directions perpendicular to the central axis of the motor are each referred to by the term “radial direction”, “radial”, or “radially”, and that a direction along a circular arc centered on the central axis of the motor is referred to by the term “circumferential direction”, “circumferential”, or “circumferentially”. It is also assumed herein that an axial direction is a vertical direction, and that a side on which a light source is arranged with respect to the motor is defined as an upper side. The shape of each member or portion and relative positions of different members or portions will be described based on the above assumptions. It should be noted, however, that the above definitions of the vertical direction and the upper side are not meant to restrict in any way the orientation of a rotary drive apparatus according to any preferred embodiment of the present invention when in use. Also note that the term “parallel” as used herein includes both “parallel” and “substantially parallel”. Also note that the term “perpendicular” as used herein includes both “perpendicular” and “substantially perpendicular”.

### 1. First Preferred Embodiment

### 1-1. Structure of Rotary Drive Apparatus

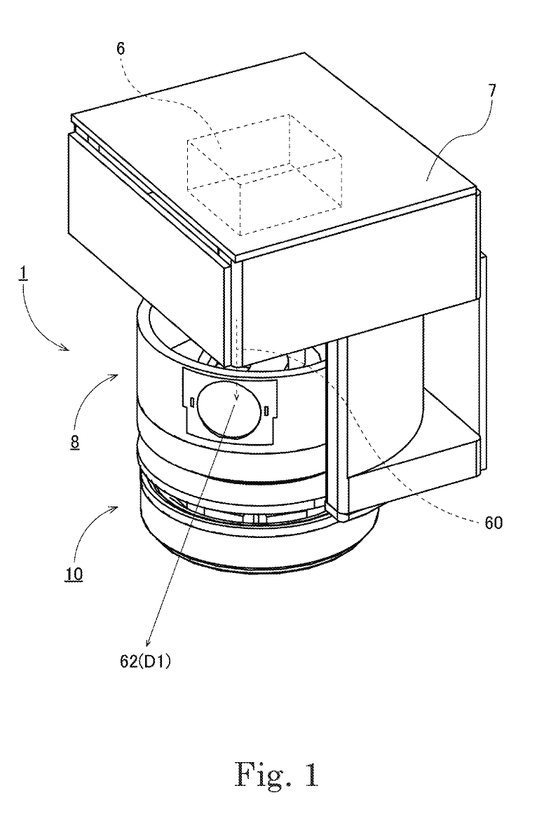

FIG. 1 is a perspective view of a light source 6, a frame 7, and a rotary drive apparatus 1 according to a first preferred embodiment of the present invention. The rotary drive apparatus 1 is an apparatus arranged to cause incoming light 60 coming from the light source 6 to be reflected in a radial direction (i.e., a first radial direction D1), and emit resulting reflected light 62 to an outside of the rotary drive apparatus 1 while rotating the reflected light 62. The frame 7, in which the light source 6 is installed, is arranged above the rotary drive apparatus 1. The frame 7 is fixed to a case or the like in which the rotary drive apparatus 1 is arranged. The incoming light 60, which travels downward along a central axis 9, which will be described below, of a motor 10, is emitted from the light source 6. In the present preferred embodiment, the light source 6 and the frame 7 are arranged outside of the rotary drive apparatus 1. Note, however, that each of the light source 6 and the frame 7 may alternatively be included in the rotary drive apparatus 1.

Referring to FIG. 1, the rotary drive apparatus 1 includes the motor 10 and a flywheel 8.

### 1-2. Structure of Motor

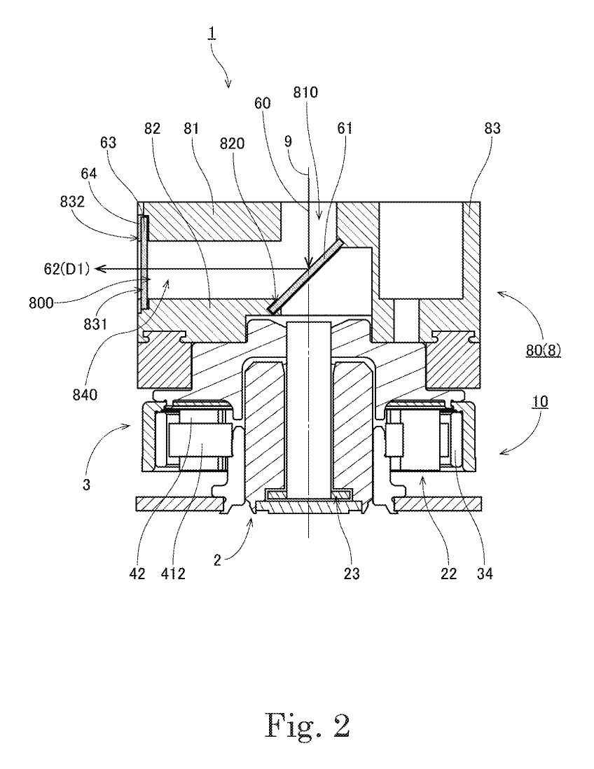

Next, the structure of the motor 10 will now be described below. FIG. 2 is a vertical sectional view of the rotary drive apparatus 1 according to the first preferred embodiment.

Referring to FIG. 2, the motor 10 includes a stationary portion 2 including a stator 22, and a rotating portion 3 including a magnet 34. The stationary portion 2 is arranged to be stationary relative to the frame 7. The rotating portion 3 is supported through a bearing portion 23 to be rotatable about the central axis 9, which extends in the vertical direction, with respect to the stationary portion 2.

Once electric drive currents are supplied to coils 42 included in the stationary portion 2, magnetic flux is generated around each of a plurality of teeth 412, which are magnetic cores for the coils 42. Then, interaction between the magnetic flux of the teeth 412 and magnetic flux of the magnet 34 included in the rotating portion 3 produces a circumferential torque between the stationary portion 2 and the rotating portion 3, so that the rotating portion 3 is caused to rotate about the central axis 9 with respect to the stationary portion 2. Thus, the flywheel 8, which is supported by the rotating portion 3 and which can be caused by the rotating portion 3 to rotate, is caused to rotate about the central axis 9 together with the rotating portion 3.

As the bearing portion 23, a fluid dynamic bearing, in which a portion of the stationary portion 2 and a portion of the rotating portion 3 are arranged opposite to each other with a gap in which a lubricating oil exists therebetween and which is arranged to induce a fluid dynamic pressure in the lubricating oil, is used, for example. Note that a bearing of another type, such as, for example, a rolling-element bearing, may alternatively be used as the bearing portion 23.

### 1-3. Structure of Flywheel

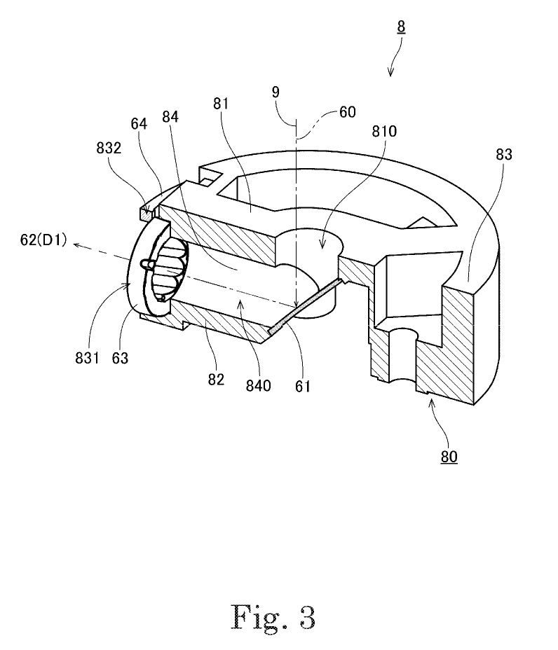

Next, the structure of the flywheel 8 will now be described below. Hereinafter, reference will be made to FIGS. 1 and 2 appropriately as well as FIGS. 3, 4, 5, and 6, which will be described below.

FIG. 3 is a perspective sectional view of the flywheel 8 according to the first preferred embodiment. The flywheel 8 is arranged below the light source 6, and is supported by an upper end portion of the rotating portion 3 of the motor 10. The flywheel 8 is arranged to rotate about the central axis 9 together with the rotating portion 3. The flywheel 8 is fixed to an upper surface of the rotating portion 3 through, for example, engagement, an adhesive, or the like. Referring to FIG. 3, the flywheel 8 includes a mirror 61, a lens 63, a lens frame 64, and a main body 80. In the present preferred embodiment, the lens 63 is directly supported by the main body 80 and the lens frame 64, which is arranged to be in contact with at least a portion of a peripheral portion of the lens 63. Note, however, that the main body 80 may alternatively be arranged to indirectly support the lens 63 through the lens frame 64.

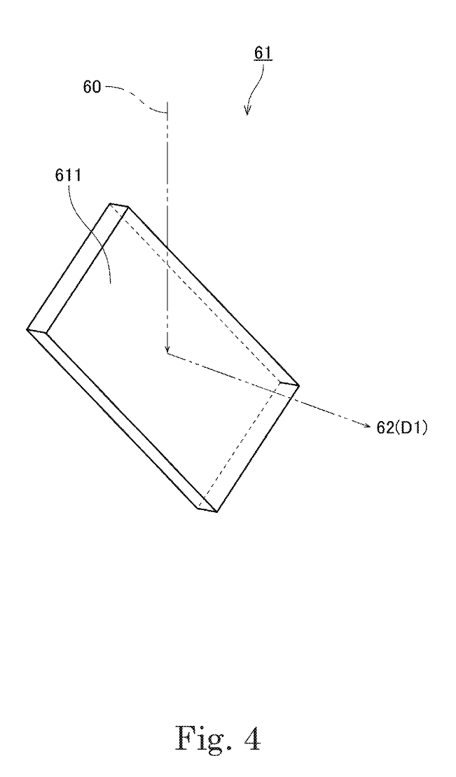

FIG. 4 is a perspective view of the mirror 61 according to the first preferred embodiment. Referring to FIG. 4, the mirror 61 is in the shape of a flat rectangular parallelepiped. In other words, the mirror 61 is in the shape of a rectangular plate. The mirror 61 is fixed to the main body 80 of the flywheel 8 with at least a portion of the mirror 61 arranged on the central axis 9. The mirror 61 is inclined at an angle of 45 degrees with respect to an axial direction and the first radial direction D1. In addition, the mirror 61 is held and fixed in a gap axially between an upper support portion 81 and a lower support portion 82, which will be described below, of the main body 80. The incoming light 60 impinges on a central portion of an upper surface 611, which is a reflecting surface, of the mirror 61. The central portion of the upper surface 611 refers to the entire upper surface 611, excluding a peripheral portion of the upper surface 611. A fully reflective mirror, for example, is used as the mirror 61. Glass is used as a material of the mirror 61. The material of the mirror is not limited to particular types of glass. For example, organic glass, inorganic glass, or the like, containing a resin, a metal, or other materials, may be used as the material of the mirror 61.

The main body 80 includes the upper support portion 81, the lower support portion 82, an outer cylindrical portion 83, and a horizontal cylindrical portion 84. A resin, for example, is used as a material of the main body 80. In the present preferred embodiment, the upper support portion 81, the lower support portion 82, the outer cylindrical portion 83, and the horizontal cylindrical portion 84 are defined as a single monolithic member by a resin injection molding process. Note, however, that the upper support portion 81, the lower support portion 82, the outer cylindrical portion 83, and the horizontal cylindrical portion 84 may alternatively be defined by separate members.

The upper support portion 81 is a portion of an upper portion of the main body 80, the portion lying inside of a peripheral portion of the upper portion of the main body 80. An upper surface of the upper support portion 81 defines at least a portion of an upper surface of the main body 80. The upper support portion 81 has a cavity 810 defined on and around the central axis 9 of the motor 10 on a radially inner side thereof. The cavity 810 is arranged to extend in parallel with the central axis 9. In addition, the cavity 810 is arranged to define a light path. At least a portion of a lower end portion of the upper support portion 81 is arranged to be in contact with at least a portion of the peripheral portion of the upper surface 611 of the mirror 61, in a state in which the mirror 61 is fixed to the flywheel 8. This contributes to more securely fixing the mirror 61.

The lower support portion 82 is a portion of a lower portion of the main body 80, the portion lying inside of a peripheral portion of the lower portion of the main body 80, and has at least a portion thereof arranged below the upper support portion 81. A lower surface of the lower support portion 82 defines at least a portion of a lower surface of the main body 80. The mirror 61 is held and fixed in a gap axially between the lower end portion of the upper support portion 81 and an upper end portion of the lower support portion 82. This contributes to more securely fixing the mirror 61. Note that the lower support portion 82 may alternatively be arranged to have a tubular structure and have a cavity defined radially inside thereof. Further, a portion of the incoming light 60 may be allowed to pass through the mirror 61, and this cavity may be arranged to define a light path along which the above portion of the incoming light 60 travels.

The outer cylindrical portion 83 is a cylindrical portion arranged to extend along the central axis 9 radially outside of the upper support portion 81. An outer circumferential surface of the outer cylindrical portion 83 defines an outer circumferential surface of the flywheel 8. In addition, a lens accommodating portion 831, which is arranged to pass through the outer cylindrical portion 83 in the first radial direction D1, is defined in the outer cylindrical portion 83 at a circumferential position radially outside of a cavity 840 of the horizontal cylindrical portion 84, which will be described below. In addition, a frame accommodating portion 832, which is recessed radially inward from the outer circumferential surface of the outer cylindrical portion 83, is defined in the outer cylindrical portion 83 at a position radially outside of the lens accommodating portion 831. An inner circumferential surface of the outer cylindrical portion 83 is joined to each of a radially outer end portion of the upper support portion 81, a radially outer end portion of the lower support portion 82, and a radially outer end portion of the horizontal cylindrical portion 84, which will be described below. Thus, the outer cylindrical portion 83, the upper support portion 81, the lower support portion 82, and the horizontal cylindrical portion 84, which will be described below, are joined to one another.

The horizontal cylindrical portion 84 is a cylindrical portion arranged to extend outward in a radial direction (i.e., the first radial direction D1) from a position axially below the cavity 810 of the upper support portion 81. An upper portion of the horizontal cylindrical portion 84 is joined to a lower surface of the upper support portion 81. In addition, a lower portion of the horizontal cylindrical portion 84 is joined to an upper surface of the lower support portion 82. The lens 63 and the lens frame are arranged radially outside of the horizontal cylindrical portion 84. The cavity 840 inside of the horizontal cylindrical portion 84 is joined to the cavity 810 of the upper support portion at right angles. Further, the cavity 840 inside of the horizontal cylindrical portion 84, the mirror 61, and the lens 63 are arranged to overlap at least in part with one another when viewed in the first radial direction D1. The cavity 840 is arranged to define a light path. At least a portion of the lens 63 is arranged to cross a light path along which the reflected light 62 travels.

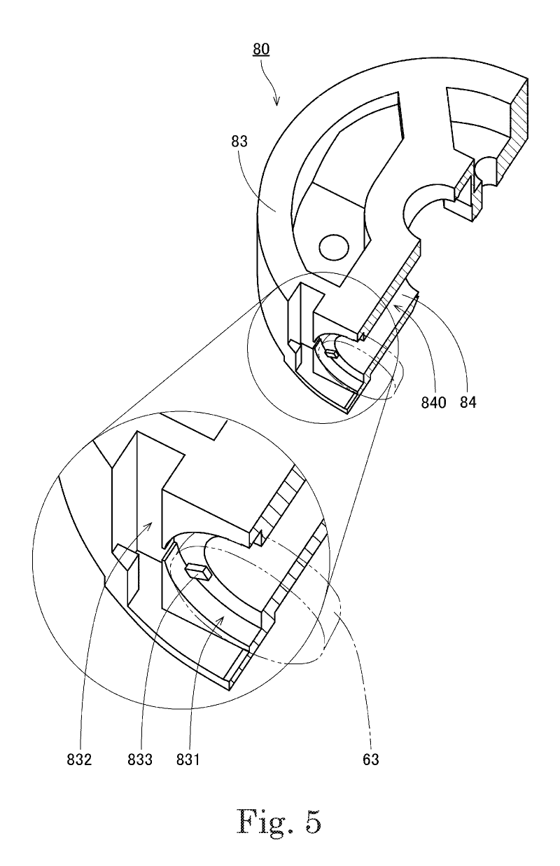

FIG. 5 is a perspective sectional view of the main body 80 of the flywheel 8 according to the first preferred embodiment. In FIG. 5, the lens 63 is represented by chain double-dashed lines. As illustrated in FIG. 5, the lens accommodating portion 831, which is a disk-shaped space, is defined in the outer cylindrical portion 83 at the circumferential position radially outside of the cavity 840 of the horizontal cylindrical portion 84. The lens accommodating portion 831 is arranged to cover an outer circumferential surface of the cavity 840 of the horizontal cylindrical portion 84. The lens 63 is arranged in the lens accommodating portion 831. In addition, the frame accommodating portion 832 is defined in the outer cylindrical portion 83 at the position radially outside of the lens accommodating portion 831. The frame accommodating portion 832 is a space recessed radially inward from the outer circumferential surface of the outer cylindrical portion 83. The frame accommodating portion 832 is exposed to an outside of the main body 80. The lens frame 64 is accommodated in the frame accommodating portion 832.

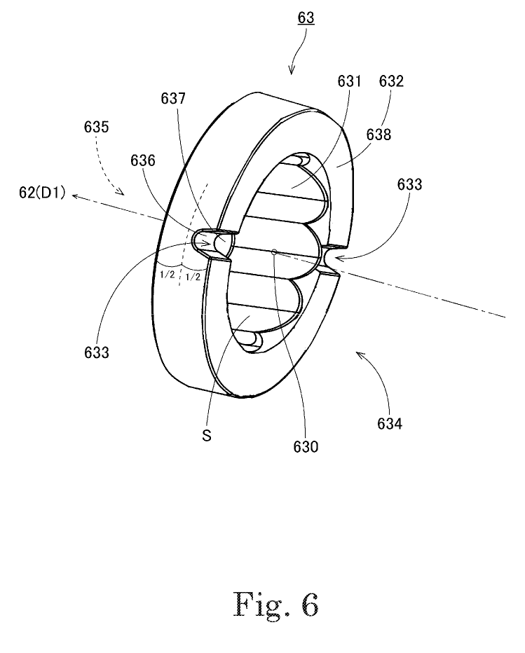

FIG. 6 is a perspective view of the lens 63 according to the first preferred embodiment. As illustrated in FIG. 6, the lens 63 is in the shape of a disk. The lens 63 is accommodated in the lens accommodating portion 831. In addition, the lens 63 is supported by the main body 80 of the flywheel 8 and the lens frame 64, which is arranged to be in contact with at least a portion of the peripheral portion of the lens 63. Further, the lens 63 is arranged at right angles to the first radial direction D1 in the lens accommodating portion 831. That is, the lens 63 is arranged in parallel with the central axis 9. An opening 800 at an outer end of the cavity 840 of the horizontal cylindrical portion 84 is covered with the lens 63. The structure of the lens 63 and a method for attaching the lens 63 to the main body 80 will be described in detail below. Glass is used as a material of the lens 63. The material of the lens 63 is not limited to particular types of glass. For example, organic glass, inorganic glass, or the like, containing a resin, a metal, or other materials, may be used as the material of the lens 63.

The incoming light 60, which is emitted from the light source 6, enters the above-described flywheel 8 from above an upper surface of the flywheel 8, and travels downward along the central axis 9 in the cavity 810 radially inside of the upper support portion 81. Then, the incoming light 60 is reflected by the mirror 61 inside of the main body 80 of the flywheel 8 to become the reflected light 62. Thereafter, the reflected light 62 further travels outward in the first radial direction D1 in the cavity 840 inside of the horizontal cylindrical portion 84, and is emitted out of the rotary drive apparatus 1 through the lens 63.

The mirror 61 of the flywheel 8 is arranged to reflect the incoming light 60 from the light source 6 and emit the reflected light 62 to the outside while rotating about the central axis 9 together with the rotating portion 3 of the motor 10. Therefore, the first radial direction D1, which is a direction in which the reflected light 62 is emitted, also rotates together with the rotating portion 3. Thus, a wide range can be irradiated with light. Note that the rotation speed of the rotary drive apparatus 1 can be recognized by sensing rotation of the reflected light 62, which is emitted out of the flywheel 8, outside of the rotary drive apparatus 1. Further, when the rotary drive apparatus 1 is used in a scanner apparatus used for position recognition in a head-mounted display (HMD) or the like, position information concerning a target person can be obtained.

Note that the rotary drive apparatus 1 may further include, in addition to the flywheel 8 arranged to emit the reflected light 62 to the outside in the first radial direction D1, another flywheel (not shown) which is arranged to emit reflected light to the outside in a second radial direction different from the first radial direction D1, and which is arranged, for example, below the motor 10. In this case, a half mirror the transmissivity and reflectivity of which are substantially equal is used as the mirror 61. Then, a half of the incoming light 60 which impinges on the mirror 61 in the flywheel 8 is reflected in the first radial direction D1 to be emitted to the outside. In addition, a remaining half of the incoming light 60 which impinges on the mirror 61 is allowed to pass through the mirror 61 and travel further downward. Further, a through hole (not shown) passing through the motor 10 in the axial direction is defined around the central axis 9 in the motor 10. Thus, the portion of the incoming light 60 which has passed through the mirror 61 passes through the through hole and reaches the other flywheel arranged below the motor 10. Then, in the other flywheel, all the remaining half of the incoming light 60 is reflected in the second radial direction, using a fully reflective mirror (not shown), to be emitted to the outside. Note that the rotary drive apparatus 1 may alternatively include, above the flywheel 8, another flywheel (not shown) which includes a half mirror and is arranged to emit reflected light in the aforementioned second radial direction. Also note that a plurality of mirrors (not shown), including a half mirror, which are arranged to reflect the incoming light 60 in mutually different directions may alternatively be installed in the single flywheel 8.

When light is emitted out in the two different directions, i.e., the first radial direction D1 and the second radial direction, as described above, light beams that are emitted out in the two different directions take different times to reach an object to be irradiated with light while the motor 10 is rotating, and this makes it possible to precisely recognize the three-dimensional position of the object in a space. Note that the other flywheel may alternatively be arranged in a rotary drive apparatus (not shown) other than the rotary drive apparatus 1 including the flywheel 8.

### 1-4. Structure for Attaching Lens to Main Body of Flywheel

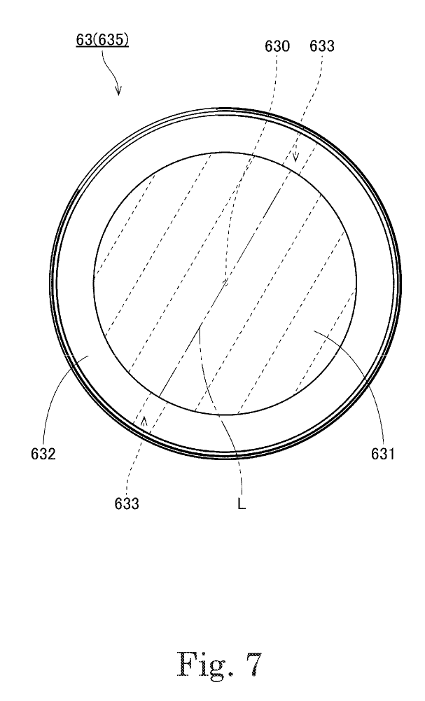

Next, a structure for attaching the lens 63 to the main body 80 of the flywheel 8 will now be described in detail below. The following description will be made with reference to FIGS. 1 to 6 appropriately as well as FIG. 7, which will be described below.

FIG. 7 is a plan view of the lens 63 according to the first preferred embodiment. A surface of the lens 63 through which the reflected light 62 enters the lens 63 and a surface of the lens 63 through which the reflected light 62, penetrating the lens 63, exits the lens 63 will be hereinafter referred to as a rear surface 634 and a front surface 635, respectively. FIG. 7 is a plan view of the lens 63 when viewed from the side of the front surface 635. Referring to FIGS. 6 and 7, the lens 63 includes a penetrable portion 631 and an impenetrable portion 632. The penetrable portion 631 is a portion of the lens 63 which lies inside of the peripheral portion of the lens 63, and allows the reflected light 62 to pass therethrough. Meanwhile, the impenetrable portion 632 is a portion of the lens 63 which lies at the peripheral portion of the lens 63, and does not allow the reflected light 62 to pass therethrough. The penetrable portion 631 has a vertically-striped relief structure S in the rear surface 634 of the lens 63.

The lens 63 includes a plurality of recessed portions 633 each of which is recessed from the rear surface 634 toward the front surface 635 of the lens 63. In the present preferred embodiment, the recessed portions 633 are arranged at regular intervals in the impenetrable portion 632 in the rear surface 634 of the lens 63. In a state in which the lens 63 is accommodated in the lens accommodating portion 831, the rear surface 634 is arranged opposite to a surface of the main body 80 of the flywheel 8, the surface including a plurality of projecting portions 833, which will be described below, in the first radial direction D1. In addition, at least two of the recessed portions 633 are arranged at positions opposed to each other with a center 630 of the rear surface 634 therebetween. Further, a straight line L joining the two recessed portions 633 is parallel to vertical stripes of the relief structure S in the rear surface 634 of the lens 63. The above arrangement of the positions of the recessed portions 633 makes it easy to position the recessed portions 633 when the flywheel 8 is manufactured.

Reference is made again to FIG. 5. In a portion of the outer circumferential surface of the outer cylindrical portion 83 which faces the lens accommodating portion 831, the main body 80 includes the projecting portions 833, each of which is arranged to project toward the lens 63 accommodated in the lens accommodating portion 831. Each projecting portion 833 is fitted in a corresponding one of the recessed portions 633 in the state in which the lens 63 is accommodated in the lens accommodating portion 831. In other words, the lens 63 is arranged in the lens accommodating portion 831 such that the projecting portions 833 of the main body 80 are fitted in the recessed portions 633 of the lens 63. This enables the lens 63 to be attached, with high precision, to the main body 80 of the flywheel 8 at a desired circumferential position and at a desired angle with respect to the main body 80. In addition, the likelihood that a displacement or rotation of the lens 63 will occur after the lens 63 is arranged in the lens accommodating portion 831 is reduced.

Each recessed portion 633 of the lens 63 is arranged to be larger than a corresponding one of the projecting portions 833 of the main body 80. Thus, even if a slight error in dimensions of any of the recessed portions 633 and the projecting portions 833 occurs in a production process, each projecting portion 833 can be successfully fitted into the corresponding recessed portion 633 at the time of the attachment of the lens 63. In addition, each recessed portion 633 is arranged to have a depth equal to or smaller than a half of the thickness of the lens 63. This ensures a sufficient strength of the lens 63.

Further, as illustrated in FIG. 6, the lens 63 includes a plate-shaped wall portion 637 between the penetrable portion 631 and a bottom surface 636, which is a surface at a bottom of the recessed portion 633. Thus, the likelihood that any projecting portion 833 will be brought into contact with the penetrable portion 631 of the lens 63 when the projecting portions 833 are fitted into the recessed portions 633 when the lens 63 is attached to the main body 80 is reduced. This in turn reduces the likelihood that the penetrable portion 631 will be damaged.

Further, the lens 63 includes one or more contact portions 638 each of which is arranged to project toward the main body 80 of the flywheel 8. Each contact portion 638 is arranged to be in contact with at least a portion of the main body 80 in the state in which the lens 63 is accommodated in the lens accommodating portion 831. This contact of each contact portion 638 with the main body 80 further reduces the likelihood of a displacement of the lens 63 with respect to the main body 80.

Note that the contact portion(s) 638 may alternatively be arranged in the main body 80. That is, the main body 80 may alternatively include one or more contact portions each of which is arranged to project toward the lens 63 to be in contact with at least a portion of the lens 63 in the state in which the lens 63 is accommodated in the lens accommodating portion 831. This arrangement also can achieve a further reduction in the likelihood of a displacement of the lens 63 with respect to the main body 80 through the contact of the contact portion(s) with the lens 63.

Reference is made again to FIG. 3. The lens frame 64 is fixed outside of the main body 80 to cover a radially outer side of the peripheral portion of the lens 63 after the lens 63 is attached to the main body 80 of the flywheel 8 as described above. At least a portion of the lens 63 is arranged radially between the main body 80 and the lens frame 64, and is held between the main body 80 and the lens frame 64. The main body 80 and the lens frame 64 thus together support the lens 63. In addition, an adhesion portion (not shown) is arranged between at least a portion of the lens frame 64 and the main body 80. Thus, the lens frame 64 is securely fixed to the main body 80. Further, the lens 63, which is arranged between the main body 80 and the lens frame 64, is more securely fixed. A metal, a resin, or the like, for example, is used as a material of the lens frame 64. A direction in which the reflected light 62 is emitted out of the flywheel 8 is stabilized when the lens 63 or the lens frame 64 is positioned with high precision with respect to the main body 80 of the flywheel 8 as described above. That is, a direction in which light is emitted out of the rotary drive apparatus 1 is stabilized. This leads to improved accuracy of an application which utilizes the reflected light 62, which is emitted with high accuracy. Examples of the application include, in addition to the head-mounted display (HMD), LiDAR (Light Detection And Ranging) and ADAS (Advanced Driver Assistance Systems), which are expected to be used for an automatic vehicle control system, and, further, an apparatus capable of accurately detecting the position of an article in a factory or a room.

### 2. Example Modifications

While preferred embodiments of the present invention have been described above, it will be understood that the present invention is not limited to the above-described preferred embodiments.

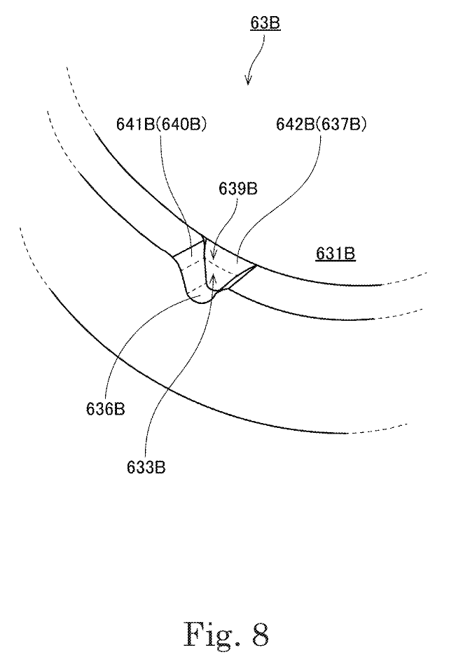

FIG. 8 is a partial perspective view of a lens 63B according to a modification of the above-described first preferred embodiment. In the modification illustrated in FIG. 8, the lens 63B includes a recessed portion 633B having an opening portion 639B defined at a radially inner end of the recessed portion 633B, a bottom surface 636B, and a side surface 640B arranged to extend from the bottom surface 636B to the opening portion 639B. The side surface 640B includes a first tapered surface 641B arranged to increase a dimension of the recessed portion 633B with decreasing distance from the opening portion 639B. Thus, when a projecting portion (not shown) of a main body of a flywheel is fitted into the recessed portion 633B when the lens 63B is attached to the main body of the flywheel, the projecting portion can be guided into the recessed portion 633B along the first tapered surface 641B. This reduces the likelihood that the projecting portion will be brought into contact with a penetrable portion 631B of the lens 63B. This in turn reduces the likelihood that the penetrable portion 631B will be damaged. Note that the recessed portion 633B may alternatively be defined in the main body of the flywheel. In this case, the first tapered surface 641B may be defined in a side surface of the recessed portion of the main body.

In addition, in the modification illustrated in FIG. 8, the lens 63B includes a wall portion 637B arranged to separate the bottom surface 636B and the penetrable portion 631B. The wall portion 637B includes a second tapered surface 642B arranged to slant while extending away from the bottom surface 636B toward the opening portion 639B. Thus, when the projecting portion (not shown) of the main body of the flywheel is fitted into the recessed portion 633B when the lens 63B is attached to the main body of the flywheel, the projecting portion can be guided into the recessed portion 633B along the second tapered surface 642B. This reduces the likelihood that the projecting portion will be brought into contact with the penetrable portion 631B of the lens 63B. This in turn reduces the likelihood that the penetrable portion 631B will be damaged.

In the above-described preferred embodiment, the plurality of recessed portions 633 are defined in the lens 63, while the plurality of projecting portions 833 are defined in an outer circumferential surface of the main body 80. Note, however, that this recess-projection relationship may be reversed. For example, the lens 63 and the main body 80 may alternatively include, respectively, a plurality of projecting portions each of which is arranged to project toward the main body 80, and a plurality of recessed portions each of which is recessed radially inward, with each projecting portion being arranged to be fitted into a corresponding one of the recessed portions. Also note that each of the number of projecting portions and the number of recessed portions may alternatively be one. That is, it may be sufficient if at least one of the lens 63 and the main body 80 includes at least one projecting portion arranged to project toward another one of the lens 63 and the main body 80, and the other one of the lens 63 and the main body 80 includes at least one recessed portion into which the corresponding projecting portion is fitted. Thus, the lens 63 is attached to the main body 80 with the projecting portion(s) being fitted into the corresponding recessed portion(s), so that the lens 63 can be attached, with high precision, to the main body 80 at a desired position and at a desired angle. In addition, the likelihood that a displacement or rotation of the lens 63 will occur after the attachment of the lens 63 can be reduced.

In the above-described preferred embodiment, at least a portion of the lens frame 64 is fixed to the main body 80 of the flywheel 8 through adhesion. Note, however, that the lens frame 64 may not necessarily be fixed by this method. For example, the lens frame 64 may alternatively be fixed to the main body 80 of the flywheel 8 through press fitting, screwing, or the like.

Note that the lens may be arranged to have a specific penetration angle at which light easily passes through the lens. For example, the above-described lens 63 may be a lens that allows light to pass therethrough only at a specific penetration angle with an optical axis of the reflected light 62 as a center. In this case, the recessed portions 633 of the lens 63 can be used to position the lens 63 at an angle in accordance with the penetration angle. For example, in the case where the penetration angle of the lens 63 is to be inclined at 45 degrees with respect to a direction in which the incoming light 60 travels with the optical axis of the reflected light 62 as the center, the lens 63 can be positioned at an appropriate angle using the recessed portions 633.

In the above-described preferred embodiment, the plurality of recessed portions 633 are arranged at regular intervals in the impenetrable portion 632, which lies at the peripheral portion of the lens 63, in the rear surface 634 of the lens 63. Note, however, that the recessed portions 633 may alternatively be arranged at irregular intervals.

Also note that the detailed shape of any member may be different from the shape thereof as illustrated in the accompanying drawings of the present application. Also note that features of the above-described preferred embodiments and the modifications thereof may be combined appropriately as long as no conflict arises.

Preferred embodiments of the present invention are applicable to, for example, rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary drive apparatus arranged to cause incoming light coming from a light source to be reflected, and rotate resulting reflected light, the rotary drive apparatus comprising:
a motor including a rotating portion arranged to rotate about a central axis extending in a vertical direction; and
a flywheel supported by the rotating portion, and caused by the rotating portion to rotate about the central axis; wherein the flywheel includes:
a lens arranged to allow the reflected light to pass therethrough; and
a main body arranged to directly support the lens, or indirectly support the lens through a lens frame arranged to be in contact with at least a portion of a peripheral portion of the lens;
at least one of the lens and the main body includes at least one projecting portion arranged to project toward another one of the lens and the main body; and
the other one of the lens and the main body includes at least one recessed portion into which the corresponding projecting portion is fitted.

2. The rotary drive apparatus according to claim 1, wherein each recessed portion is arranged to be larger than the corresponding projecting portion.

3. The rotary drive apparatus according to claim 1, wherein
each recessed portion has an opening portion, a bottom surface, and a side surface arranged to extend from the bottom surface to the opening portion; and
the other one of the lens and the main body includes, in the side surface, a first tapered surface arranged to increase a dimension of the recessed portion with decreasing distance from the opening portion

4. The rotary drive apparatus according to claim 1, wherein
the main body includes a plurality of the projecting portions, each projecting portion being arranged to project toward the lens; and
the lens includes a plurality of the recessed portions, each recessed portion being recessed from a rear surface toward a front surface of the lens.

5. The rotary drive apparatus according to claim 4, wherein
the lens further includes one or more contact portions each of which is arranged to project toward the main body; and
each contact portion is arranged to be in contact with at least a portion of the main body.

6. The rotary drive apparatus according to claim 4, wherein
the main body further includes one or more contact portions each of which is arranged to project toward the lens; and
each contact portion is arranged to be in contact with at least a portion of the lens.

7. The rotary drive apparatus according to claim 1, wherein the recessed portion is arranged to have a depth equal to or smaller than a half of a thickness of the lens.

8. The rotary drive apparatus according to claim 4, wherein the recessed portions are arranged at regular intervals in a peripheral portion of the rear surface of the lens, the rear surface being arranged opposite to a surface of the main body, the surface including the projecting portions.

9. The rotary drive apparatus according to claim 8, wherein at least two of the recessed portions are arranged opposed to each other with a center of the rear surface of the lens therebetween.

10. The rotary drive apparatus according to claim 9, wherein
the lens includes:
a penetrable portion arranged to allow the reflected light to pass therethrough; and
an impenetrable portion arranged at the peripheral portion of the lens, and arranged not to allow the reflected light to pass therethrough;
the penetrable portion has a vertically-striped relief structure in a surface thereof through which the reflected light enters the penetrable portion; and
a straight line joining the two recessed portions is parallel to vertical stripes of the relief structure.

11. The rotary drive apparatus according to claim 4, wherein
the lens includes:
a penetrable portion arranged to allow the reflected light to pass therethrough; and
an impenetrable portion arranged at the peripheral portion of the lens, and arranged not to allow the reflected light to pass therethrough;
each recessed portion is defined in the impenetrable portion, and has a bottom surface and an opening portion; and
the lens further includes a plate-shaped wall portion between the bottom surface of the recessed portion and the penetrable portion.

12. The rotary drive apparatus according to claim 11, wherein the wall portion of the lens includes a second tapered surface arranged to slant while extending away from the bottom surface of the recessed portion toward the opening portion.

13. The rotary drive apparatus according to claim 1, wherein
the flywheel further includes a mirror arranged to reflect the incoming light;
the lens is arranged to have a penetration angle at which light easily passes through the lens; and
the penetration angle of the lens is inclined at 45 degrees with respect to a direction in which the incoming light travels with an optical axis of the reflected light as a center, the reflected light being obtained by the mirror reflecting the incoming light.

14. The rotary drive apparatus according to claim 1, wherein
the lens includes a plurality of the projecting portions, each projecting portion being arranged to project toward the main body; and
the main body includes a plurality of the recessed portions, each recessed portion being recessed radially inward.

15. The rotary drive apparatus according to claim 1, wherein at least a portion of the lens is arranged radially between the main body and the lens frame, and is held between the main body and the lens frame.

16. The rotary drive apparatus according to claim 1, wherein an adhesion portion is arranged between at least a portion of the lens frame and the main body.
